(19) United States
(12) Patent Application Publication
(10) Pub. No.: US 2015/0139385 A1
(43) Pub. Date: May 21, 2015

(54) ROTATIONAL PHASE UNWRAPPING

(71) Applicant: CANON KABUSHIKI KAISHA, Tokyo (JP)

(72) Inventors: DONALD JAMES BONE, Wentworth Falls (AU); Alexander David CORBETT, Marsfield (AU)

(21) Appl. No.: 14/548,693

(22) Filed: Nov. 20, 2014

(30) Foreign Application Priority Data
Nov. 20, 2013 (AU) 2013260650

(51) Int. Cl. G01N 23/20; G01B 11/22

(52) U.S. Cl. CPC G01N 23/20075; G01B 11/22
USPC 378/36

(57) ABSTRACT

A phase unwrapping method for image demodulation comprises receiving a plurality of images of a fringe pattern captured by rotating the fringe pattern by a predetermined rotation angle. The method estimates a first wrapped phase value for a portion of a first image of the plurality of images and a second wrapped phase value for a corresponding portion of a second image, and establishes a first plurality of elements associated with the first wrapped phase value. For a candidate element from the first plurality of elements, the method determines a constraining element associated with the candidate element using the second wrapped phase value, where the association is established using the candidate element and the predetermined rotation angle, and unwraps the phase for the portion of at least one of the first and second images using the candidate element based on the determined constraining element.

### REFERENCE TO RELATED PATENT APPLICATION(S)

This application claims the benefit under 35 U.S.C. §119 of the filing date of Australian Patent Application No. 2013260650, filed Nov. 20, 2013, hereby incorporated by reference in its entirety as if fully set forth herein.

### TECHNICAL FIELD

This invention is in the field of phase unwrapping and relates to the demodulation of phase information from a set of one-dimensional or two-dimensional fringe pattern images.

### BACKGROUND

Standard methods for obtaining the optical path difference introduced by an object through its surface profile (reflection) or refractive index change (transmission) act to modulate the phase of a known intensity pattern. The intensity pattern may be a one-dimensional fringe pattern (e.g. a sinusoidal fringe pattern) or a two-dimensional fringe pattern (e.g. a crossed grating) and may be composed of one or more spatial frequencies. At each point on the object of interest, the phase of the known fringe pattern is modulated by the object. The phase modulation introduced by the object has both a direction and a magnitude which has a physical correlate of interest (such as optical path difference) and must be deduced from the fringe pattern. The magnitude of the phase modulation introduced by the object may be multiple phase cycles. Existing methods in fringe projection such as phase stepping or Fourier fringe analysis provide a measure of the phase profile of the object which is wrapped (modulo 2π) and therefore ambiguous up to an offset of an integer multiple of 2π. The research problem then centres around providing a suitable approach which can recover the true, unwrapped phase profile from the wrapped phase profile. This problem becomes more difficult in the presence of noise and discontinuities, which occur due to edges of the object. There have been many proposed solutions to this fundamental problem, each with their own limitations. In general these existing solutions can be divided into spatial and temporal methods for the unwrapping of phase.

### Spatial Methods

In the absence of noise or discontinuities, phase unwrapping in two dimensions for a well sampled signal becomes a trivial problem. For a well sampled signal with more than two samples per cycle, a simple approach has been to perform a pixel-wise raster scan across the wrapped phase map and assess the phase difference between adjacent pixels. Wrapping causes the phase between adjacent pixels to occasionally appear to increase or decrease by more than π. When this occurs the wrapped phase is increased or decreased by 2π. With the addition of multi-cycle discontinuities, the form of the recovered phase map becomes dependent upon the point at which the unwrapping algorithm begins, i.e. the result is said to be path-dependent. This is a major limitation as it means that the solution to the unwrapped phase is no longer unique, but dependent upon the starting point of the algorithm. As there is only one true unique value for the unwrapped phase, adopting a path-dependent phase unwrapping approach has been found to be unreliable at best.

Earlier approaches first identified phase discontinuities and then removed them from the phase map. A more sophisticated approach obtained two phase gradient maps (X and Y) from the wrapped phase map by calculating the difference between neighbouring pixels in X and then Y. The gradient maps were then used to perform an integration which gave a least squares phase error. This method, even in its regularised form is nevertheless limited to continuous (well sampled) phase functions. As there is every possibility that the desired unwrapped phase maps will contain phase discontinuities (i.e. a phase change of more than π between adjacent pixels), it is likely that this method will fail for many of the cases of interest.

### Temporal Methods

Temporal methods do not attempt to unwrap the phase by integrating the wrapped phase along a particular path, but rather unwrap the phase by acquiring a temporal sequence of fringe patterns and then performing pixel-wise phase unwrapping along the temporal axis. One well established method begins with a fringe pattern with a sufficiently long period that even large discontinuities do not lead to phase wrapping. This coarse, unwrapped phase estimate is then supplemented by subsequent fringe patterns of higher spatial frequency to increase sensitivity and reduce phase errors. For each fringe pattern, the wrapped phase is measured using existing techniques, such as phase stepping or the Fourier Transform method. The unwrapped phase can then be determined by summing the differences in wrapped phase value between subsequent fringe patterns. If the increments in spatial frequency are sufficiently small that phase changes between images are always less than 2π, then in principle any size of phase discontinuity can be disambiguated.

One of the main issues with the spatial and temporal approaches is that many fringe pattern images are required to recover accurate unwrapped phase values. For applications requiring multi-cycle phase information with low latency, such as depth estimation, this becomes a major problem. For other applications which involve administering a dose of X-ray radiation to obtain an intensity image of a patient, the use of multiple exposures presents a health risk.

### SUMMARY

According to one aspect of the present disclosure there is provided a phase unwrapping method for image demodulation, the method comprising:

receiving a plurality of images of a fringe pattern, the images being captured by rotating the fringe pattern by a predetermined rotation angle;

estimating a first wrapped phase value for a portion of a first image of the plurality of images and a second wrapped phase value for a corresponding portion of a second image of the plurality of images;

establishing a first plurality of elements associated with the first wrapped phase value;

for a candidate element from the first plurality of elements associated with the first wrapped phase value, determining a constraining element associated with the candidate element using the second wrapped phase value, wherein the association is established using the candidate element and the predetermined rotation angle; and,

unwrapping the phase for the portion of at least one of the first and second images using the candidate element based on the determined constraining element.

According to another aspect of the present disclosure there is provided a phase unwrapping method for image demodulation, the method comprising:

receiving a plurality of images of a fringe pattern, the images being captured by rotating the fringe pattern by a predetermined rotation angle;

estimating a first wrapped phase value for a portion of a first image of the plurality of images and a second wrapped phase value for a corresponding portion of a second image of the plurality of images;

for a candidate element formed by applying an integer number of cycles to the first wrapped phase value, determining a constraining element associated with the candidate element using the second wrapped phase value, wherein the association is established using the candidate element and the predetermined rotation angle; and,

unwrapping the phase for the portion of at least one of the first and second images using the candidate element based on the determined constraining element.

Desirably the fringe pattern is a two-dimensional fringe pattern. Preferably the method generates the fringe pattern using a two-dimensional crossed grating. In another implementation the method captures the plurality of images using at least two orthogonal gratings, wherein each grating forms a one-dimensional fringe pattern. Desirably this can involve rotating two gratings together by the predetermined rotation angle.

In a further implementation the method comprises estimating the wrapped phase values by capturing a plurality of images with predetermined phase steps of an imaging source from which the fringe patterns are formed.

Advantageously the wrapped phase is in two-dimensional space comprising X and Y components.

Another implementation comprises establishing the candidate element by addition or subtraction of an integer number of cycles in at least one direction for the wrapped phase values.

The method may comprise rotating the candidate element by the predetermined rotation angle to determine the constraining element. Here, the method may further comprise establishing a second plurality of elements associated with the second wrapped phase value, the second plurality being established by addition an integer number of cycles in at least one direction to the second wrapped phase value. Desirably the number of cycles is determined using at least one of the periodicity of the fringe pattern and an object being imaged. Also the constraining element can be selected from the second plurality using a distance between the candidate element rotated to the predetermined rotation angle and at least one element from the second plurality. Alternatively the constraining element from the second plurality may be selected by considering a vector representation of the unwrapped phase values, so that a vector phase magnitude of the candidate element substantially equals vector phase magnitude of the constraining element, and thereby forming the pair of unwrapped phase values. Here the unwrapping may further comprise using the candidate element in the pair of unwrapped phase values as the true unwrapped phase value for the portion. In another implementation the constraining element may be selected by comparing the distance between the candidate element rotated to the predetermined rotation angle and at least one element from the second plurality against a predetermined threshold, so that the distance is less than the predetermined threshold. Desirably the unwrapping further comprises using the candidate element associated with the selected constraining element as the true unwrapped phase value for the portion.

In another example the method may comprise capturing the plurality of images by projecting a two-dimensional fringe pattern onto an object.

According to yet another aspect of the present disclosure there is provided a method for image demodulation by phase unwrapping, the method comprising:

receiving a plurality of images of a fringe pattern, the images being captured by rotating the fringe pattern by a predetermined rotation angle;

estimating a first wrapped phase value for a portion of a first image of the plurality of images and a second wrapped phase value for a corresponding portion of a second image of the plurality of images;

establishing a first plurality of elements associated with the first wrapped phase value;

rotating a candidate element from the first plurality of elements by the predetermined rotation angle to determine a constraining element associated with the second wrapped phase value; and

unwrapping the phase for the portion of the first image using the candidate element based on the determined constraining element.

Desirably the unwrapping comprises wrapping the constraining element and comparing a magnitude of a distance between the wrapped constraining element and the second wrapped phase value against a predetermined threshold, such that where the distance is less than the predetermined threshold, the candidate element is selected as the true demodulated unwrapped phase value for the portion.

According to another aspect of the present disclosure there is provided an X-ray Talbot interferometry system comprising:

an imaging system for capturing a plurality of images of a fringe pattern formed by a plurality of gratings using the Talbot effect, the images being captured by rotating the fringe pattern by a predetermined rotation angle; and

a processor system configured to demodulate the images using phase unwrapping, the processor system being operable to:
estimate a first wrapped phase value for a portion of a first image of the plurality of images and a second wrapped phase value for a corresponding portion of a second image of the plurality of images;
establish a first plurality of elements associated with the first wrapped phase value;
for a candidate element from the first plurality of elements, determine a constraining element associated with the candidate element using the second wrapped phase value, wherein the association is established using the candidate element and the predetermined rotation angle; and
unwrap the phase for the portion of the first image using the candidate element based on the determined constraining element.

More generally disclosed is a depth estimation system comprising:

a source for projecting a two-dimensional fringe pattern onto an object, the projecting including a plurality of rotations of the fringe pattern through a predetermined rotation angle;

an imaging device for capturing a plurality of images of the fringe pattern on the object from the plurality of rotations; and

a processor system configured to demodulate the images using phase unwrapping, the processor system being operable to:
estimate a first wrapped phase value for a portion of a first image of the plurality of images and a second wrapped phase value for a corresponding portion of a second image of the plurality of images;
establish a first plurality of elements associated with the first wrapped phase value;
for a candidate element from the first plurality of elements, determine a constraining element associated with the candidate element using the second wrapped phase value, wherein the association is established using the candidate element and the predetermined rotation angle;
unwrap the phase for the portion of the first image using the candidate element based on the determined constraining element; and
estimate a depth of the object at the portion using the unwrapped phase for the portion.

Other aspects are also disclosed.

### BRIEF DESCRIPTION OF THE DRAWINGS

At least one embodiment of the invention will now be described with reference to the following drawings, in which:

FIG. 1 is a schematic flow diagram illustrating a method of obtaining two unwrapped phase values from two pairs of wrapped phase values;

FIG. 2 is a two-dimensional phase-space diagram used to illustrate the method outlined in FIG. 1;

FIG. 3 is a schematic flow diagram illustrating a method of obtaining two unwrapped phase values from two pairs of wrapped phase values using an alternative implementation of the method illustrated in FIG. 1 which saves an additional calculation step by creating a second plurality of candidate solutions;

FIG. 4 is a two-dimensional phase-space diagram used to illustrate the method outlined in FIG. 3;

FIG. 5 is a schematic flow diagram illustrating a method of obtaining two unwrapped phase values from two pairs of wrapped phase values using an alternative implementation of the method illustrated in FIG. 1 which allows for an exhaustive search of the search space;

FIG. 6 is a schematic illustration of an experimental X-ray Talbot interferometer, in which the arrangements described may be implemented;

FIGS. 7A to 7C illustrate examples of the gratings and the self-image described in FIG. 6;

FIG. 7D shows how 1-dimensional fringe patterns may be used;

FIG. 8 illustrates the basic components of a depth estimation system using structured illumination;

FIG. 9 illustrates the application of rotational phase shifting to depth estimation from rotational phase shifting;

FIGS. 10A to 10D provides an analysis of the application of the presently disclosed arrangements to simulated X-ray Talbot imaging data; and

FIGS. 11A and 11B form a schematic block diagram of a general purpose computer system upon which arrangements described can be practiced.

### DETAILED DESCRIPTION INCLUDING BEST MODE

### Context

The demodulation methods disclosed in this document can be applied to a broad range of systems which infer real world information from the phase modulation of a known periodic pattern. For the purposes of providing a more concrete context, two example systems to which the methods can be successfully applied are described.

### X-Ray Talbot Imaging

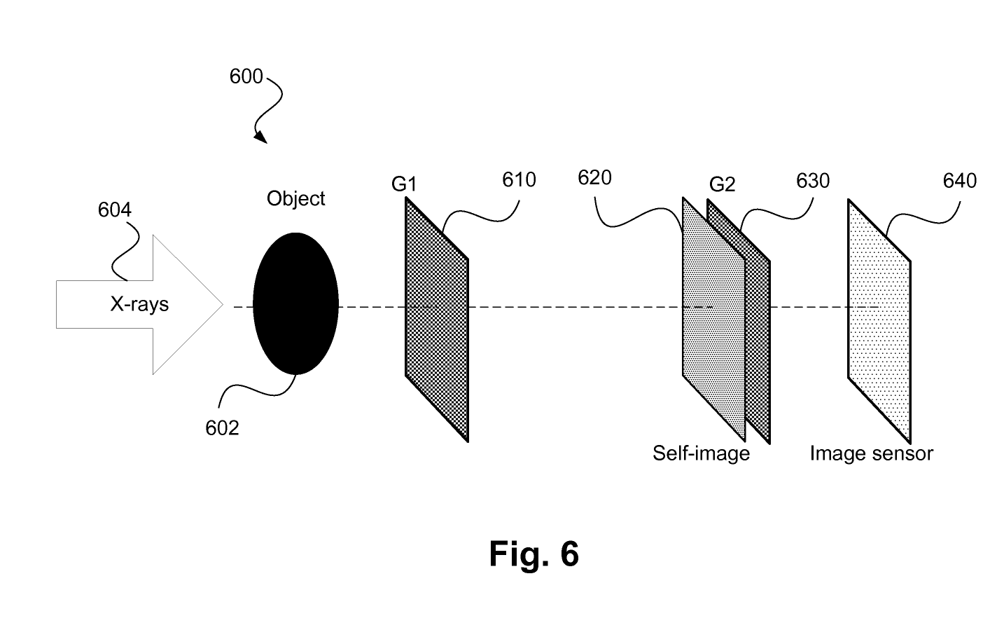

An X-ray Talbot interferometry system captures fringe patterns generated by an object through several gratings using the Talbot effect in order to recover information about the object. Because this type of X-ray imaging uses phase differences instead of absorption to produce contrast, the accuracy is higher than regular X-ray imaging. In this application, the challenge is to recover the optical path length changes across the object of interest (as depicted in FIG. 6) using the minimum exposure to X-ray radiation.

In an X-ray Talbot interferometry (XTI) system 600, schematically shown in FIG. 6, a phase grating G1 610 and an object 602 being imaged are illuminated by X-rays 604. The phase grating G1 may be a 2D crossed grating. In other implementations the phase grating G1 may be a 1D linear grating which can be rotated by 90 degrees to determine x and y phase components. The phase grating G1 may also be manufactured as two orthogonal 1D linear gratings. A self-image 620 is formed behind the phase grating G1 610 due to the Talbot effect. Since the phase of the illuminating X-ray wave is perturbed by the object 602, the self-image 620 is deformed. By analysing the deformed self-image 620, the characteristics of the object 602 can be deduced. In FIG. 6, an absorption grating G2 630 is placed at the position of the self-image 620, and rotated with respect to the grating G1 610, to generate a moiré fringe pattern. The phase grating G1 may be a 2D grating or may be formed of two orthogonal gratings. During rotation, only G1 and G2 need to be rotated together to identify a second wrapped phase value. The period of the absorption grating G2 630 is configured, designed or selected to be similar to that of the self-image 620 so the moiré pattern generated by superposing the deformed self-image 620 and G2 (630) gives a much larger version of the original self-image in order for an image sensor 640 to detect and resolve the pattern. The object 602 may be any object at least translucent to X-rays, and is typically a biological sample or specimen.

Using the above described initial arrangement of the phase grating G1 (1D linear grating), an x-wrapped phase component can be estimated, while a y-wrapped phase component can be estimated by rotating the phase grating G1 by 90 degrees. The same process may be carried out for a predetermined rotation angle.

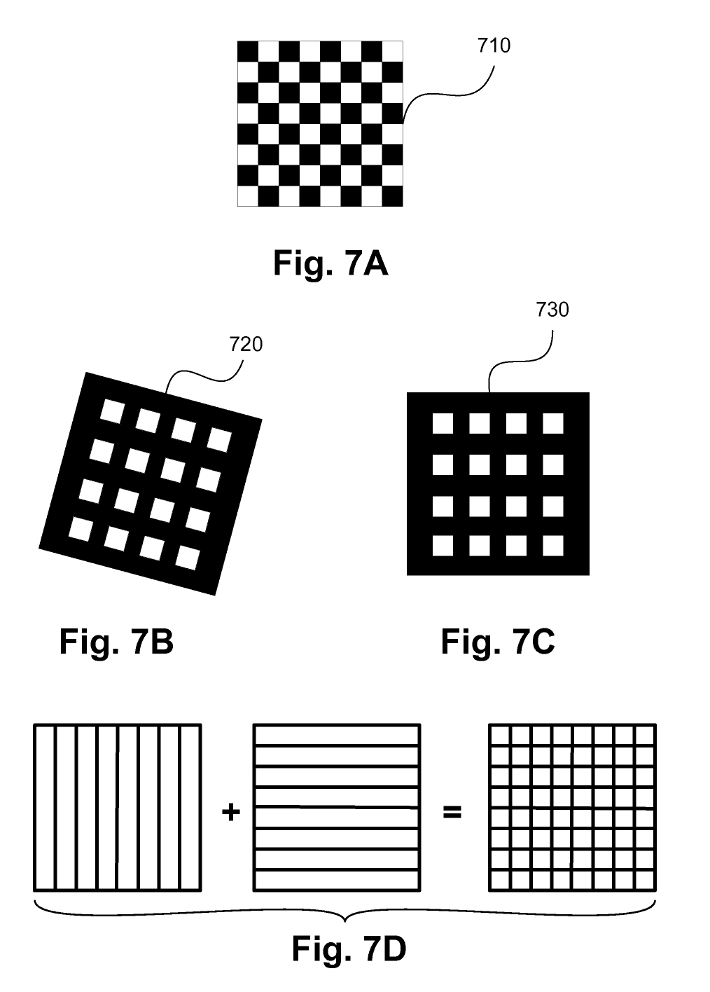

The gratings G1 610 and G2 630 used in the X-ray interferometry system have two-dimensional (2D) structures as illustrated in FIGS. 7A to 7C. FIG. 7A shows a common design 710 for the grating G1 610, in which the dark areas represent regions on G1 610 where a phase shift of π is imposed, and the bright areas represent regions on G1 610 where no phase shift is imposed. FIG. 7B shows a common design 720 for the grating G2 630, in which the dark areas represent regions on G2 630 that absorb most of the X-ray energy, and the bright areas represent regions on G2 630 that let through or pass the X-ray energy. The example 720 of G2 630 shown is slightly tilted for the purpose of generating moiré patterns and is separate to the rotation used for phase unwrapping. An X-ray Talbot interferometry system may be implemented in a manner different to that illustrated in FIG. 6, but generally is a variation of the system in FIG. 6. FIG. 7C shows an illustration 730 of the self-image 620 generated from the grating 710 without an object 620 present. By superposing the self-image 620 and G2 630, with G2 630 having similar structure to the self-image 620 and rotated by a small angle, a moiré pattern is produced. The phase information of the object 602 in FIG. 6 remains in the moiré pattern but is present at a much lower frequency compared to the self-image 620. An exemplary image sensor 640, even with limited resolution ability, can typically resolve the magnified self-image, and from which the phase information of the object 602 can be recovered.

The image captured by the image sensor 640 is composed of an intensity pattern which is periodic in two orthogonal directions and can be described as a two-dimensional crossed fringe pattern. Through the rotation of gratings G1 610 and G2 630 together, in a synchronized tandem fashion, the orientation of the captured two-dimensional fringe pattern will change, but the periodicity of the fringe pattern will remain unchanged. By capturing the wrapped phase values of the two-dimensional fringe pattern at two orientations (θ1 and θ2), it is possible to employ the method disclosed in this description to unwrap the phase values at each point in the captured image. This is significant as the unwrapped phase relates directly to the gradient of the optical path length through the object 602 which is used to calculate the phase contrast image. The ability to capture accurate phase information with fewer exposures represents a significant improvement to the state of the art in X-ray Talbot imaging.

### Structured Illumination for Depth Estimation

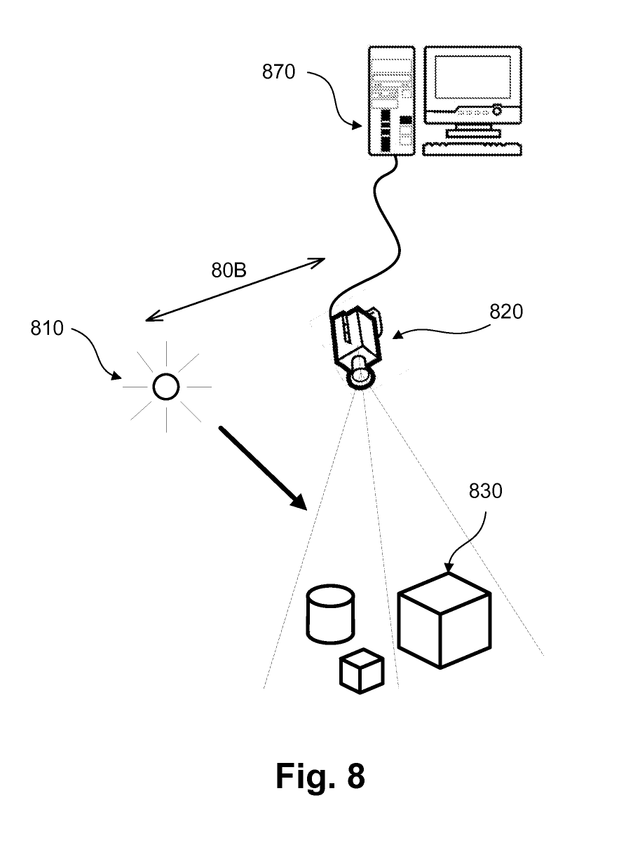

In the field of depth estimation, structured illumination is one method that can be employed to remotely determine the surface profile (topography) of an object or a scene. Structured illumination is an active method of depth estimation that operates using triangulation, as depicted in FIG. 8. Structured illumination systems are composed of three basic elements; (i) a means 810 of projecting a structured light pattern, such as a sinusoidal fringe pattern, onto an object or scene 830, (ii) a means 820 of collecting and recording the light scattered by the surface of objects in the scene 820, generally known as a detector, and (iii) a means 870 of processing the recorded images captured by the detector 820. The triangulation arises from the physical disposition of the light source 810, the object or scene 830, and the detector 820. Structured illumination is active in the sense that the object or scene 830 is typically actively illuminated by a projector, operating as the light source 810, and which projects a specially configured structured illumination pattern. In structured illumination methods, triangulation is used to translate unwrapped phase values into surface height, which requires knowledge of the physical separation between the projector 810 and the detector 820, known as the baseline, labelled ‘80B’ in FIG. 8. Applications in depth estimation such as human—computer interfaces and self-navigating robotics require very low latency measurement of the depth in a scene. Rotational phase unwrapping is proposed as a method in which accurate depth information from structured illumination methods can be obtained using fewer captured images, thereby decreasing overall system latency.

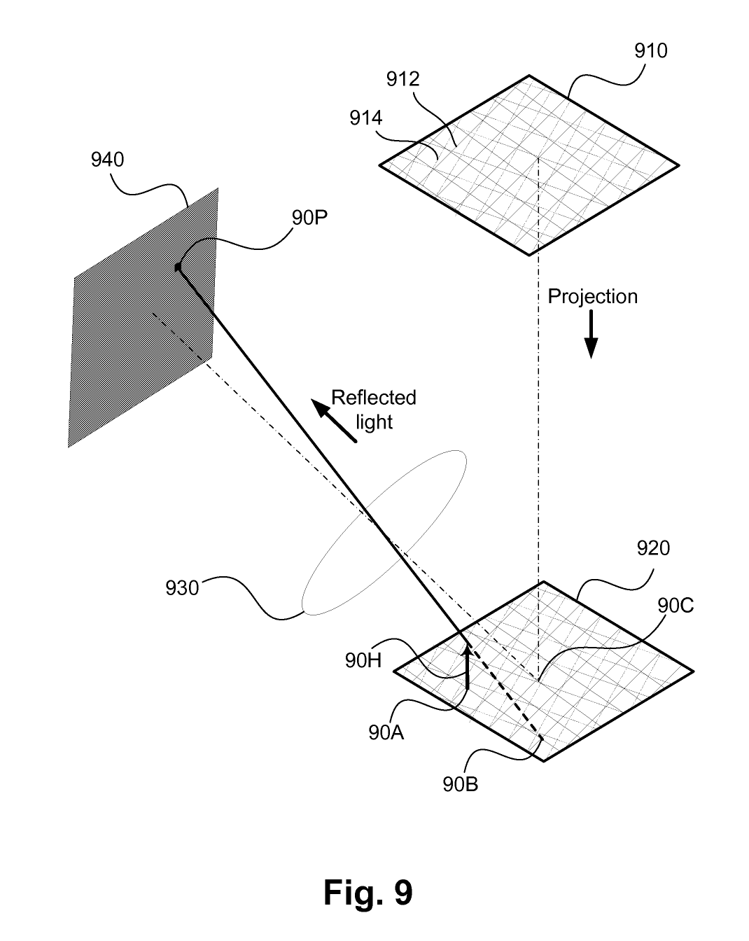

For simplicity, the structured illumination system considered here uses parallel projection to avoid the need to calibrate for the effects of distortion when projecting onto a plane, for example as illustrated in FIG. 9. Also for simplicity, it is assumed that the object of interest in a scene is completely contained by the depth of field of the projection optics of the projector 810. In the example illustrated in FIG. 9, a projector (not illustrated) projects a two-dimensional fringe pattern 910 onto a scene (not illustrated). Intensity images are then captured using collection optics 930 and a sensor 940 from light reflected from the scene. The projected two-dimensional fringe pattern 910 is rotated at predetermined angles θ1 (represented by solid line grid 912 in FIG. 9) and θ2 (represented by dotted line grid 914 in FIG. 9) about a centre of rotation, ‘90C’.

The projected fringe pattern rotation angles θ1 and θ2 are measured using a first set of images captured without the object present and with respect to a fixed coordinate system in the plane of a planar reference surface 920. A second set of images are then captured for each rotation angle (θ1 and θ2) of the projected two-dimensional fringe pattern but with the object of interest or scene introduced to the sensor side of the planar reference surface 920. The additional height (labelled ‘90H’ in FIG. 9) of a point on the object surface above the reference plane will change the intensity measured at a given point on the sensor (labelled ‘90P’ in FIG. 9) such that the phase value on the two-dimensional fringe pattern corresponding to the measured intensity will change from the phase at the point labelled 90B to the phase at the point labelled 90A. However, as only the wrapped phase value is recovered from intensity values recorded at any given point in the image, the number of complete phase cycles that have been introduced between the phase values at 90A and the phase values at 90B is unknown. In order to unambiguously determine the height of each point on the object, the phase values must be unwrapped. Through the application of the method disclosed in this document it is possible to unwrap these phase values and uniquely determine the height of each point on the object surface.

### Computerized Implementation

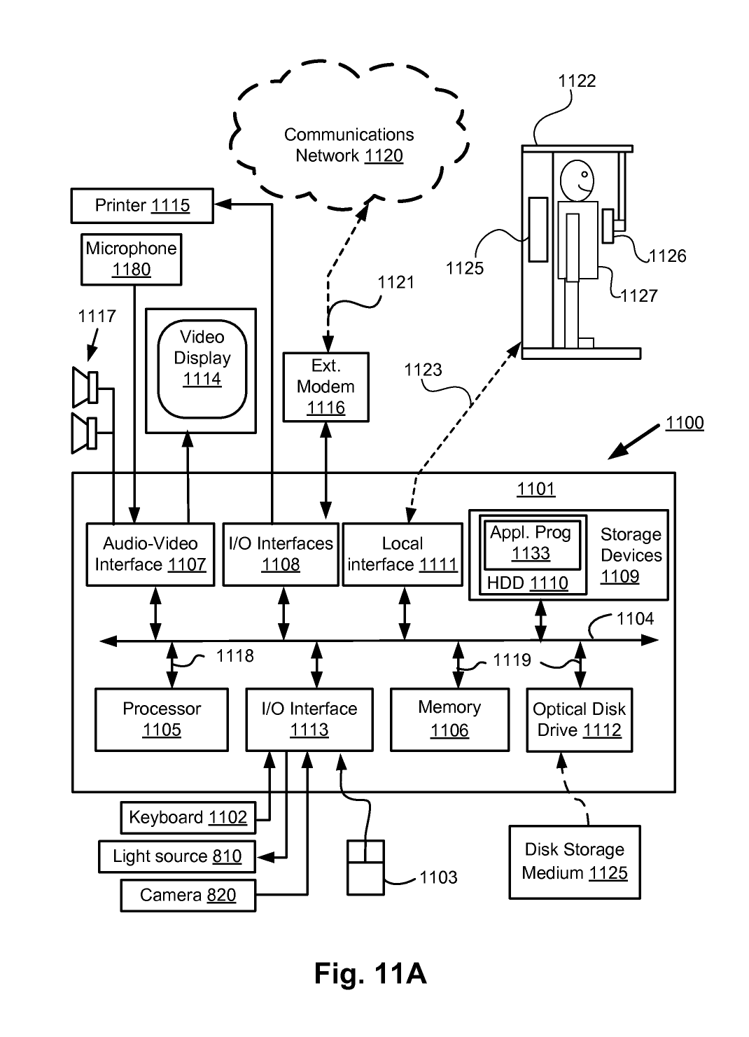

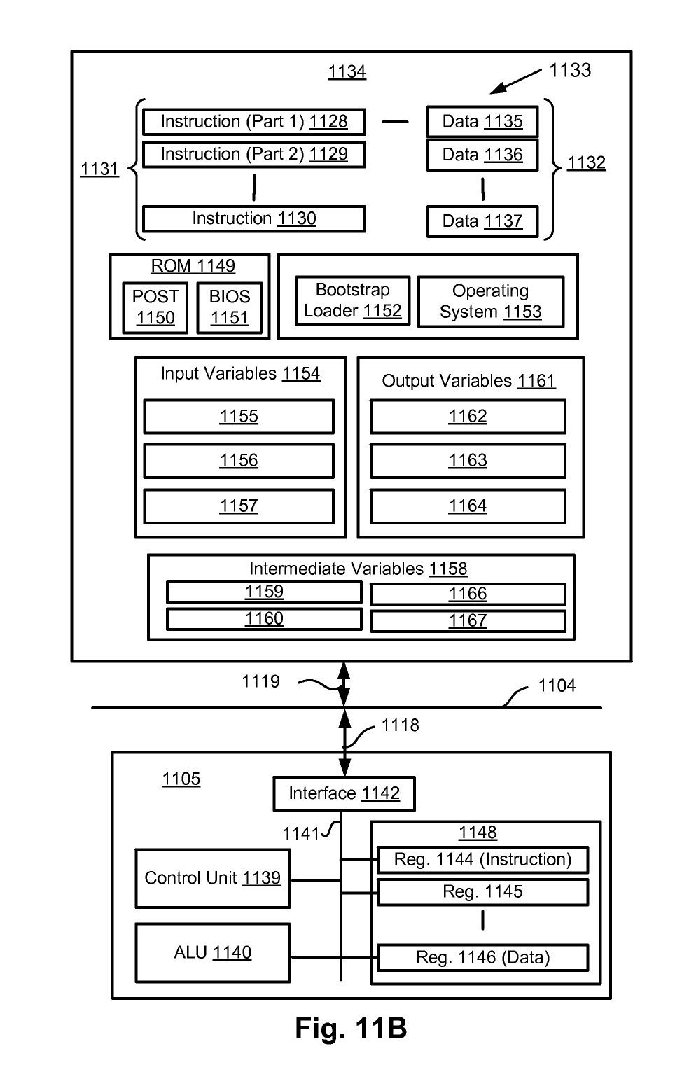

FIGS. 11A and 11B depict a general-purpose computer system 1100, upon which the various arrangements described can be practiced as relevant to one or both of the arrangements of FIGS. 6 and 8.

As seen in FIG. 11A, the computer system 1100 includes: a computer module 1101; input devices such as a keyboard 1102, a mouse pointer device 1103, a camera 820 such as that seen in FIG. 8, a microphone 1180, and an X-ray system 1122 consistent with FIG. 6; and output devices including a printer 1115, a display device 1114, loudspeakers 1117, and a light source 810 such as seen in FIG. 8. An external Modulator-Demodulator (Modem) transceiver device 1116 may be used by the computer module 1101 for communicating to and from a communications network 1120 via a connection 1121. The communications network 1120 may be a wide-area network (WAN), such as the Internet, a cellular telecommunications network, or a private WAN. Where the connection 1121 is a telephone line, the modem 1116 may be a traditional “dial-up” modem. Alternatively, where the connection 1121 is a high capacity (e.g., cable) connection, the modem 1116 may be a broadband modem. A wireless modem may also be used for wireless connection to the communications network 1120.

The computer module 1101 typically includes at least one processor unit 1105, and a memory unit 1106. For example, the memory unit 1106 may have semiconductor random access memory (RAM) and semiconductor read only memory (ROM). The computer module 1101 also includes an number of input/output (I/O) interfaces including: an audio-video interface 1107 that couples to the video display 1114, loudspeakers 1117 and microphone 1180; an I/O interface 1113 that couples to the keyboard 1102, mouse 1103, light source 810, camera 820 and optionally a joystick or other human interface device (not illustrated); and an interface 1108 for the external modem 1116 and printer 1115. In some implementations, the modem 1116 may be incorporated within the computer module 1101, for example within the interface 1108. The computer module 1101 also has a local interface 1111, which permits coupling of the computer system 1100 via a connection 1123 to the X-ray device 1122.

As illustrated in FIG. 11A, the X-ray device 1122 may be a sizeable apparatus configured for imaging human anatomy, or where desired inanimate objects such as parts, components, and other man-made structures, as well as plants and the like. Alternatively, the X-ray apparatus 1122 may be configured as a microscope for the X-ray Talbot imaging and examination of biological or cellular samples and small sized structures. The X-ray device 1122 as illustrated includes an emission portion 1126 for directing X-rays through a specimen 1127 for detection by an imaging system 1125 akin to that discussed above with reference to FIG. 6. For implementations involving the camera 820 and light source 810, such necessitates configuring the same in the manner shown in FIG. 9 as discussed above.

The I/O interfaces 1108 and 1113 may afford either or both of serial and parallel connectivity, the former typically being implemented according to the Universal Serial Bus (USB) standards and having corresponding USB connectors (not illustrated). Storage devices 1109 are provided and typically include a hard disk drive (HDD) 1110. Other storage devices such as a floppy disk drive and a magnetic tape drive (not illustrated) may also be used. An optical disk drive 1112 is typically provided to act as a non-volatile source of data. Portable memory devices, such optical disks (e.g., CD-ROM, DVD, Blu-ray Disc™), USB-RAM, portable, external hard drives, and floppy disks, for example, may be used as appropriate sources of data to the system 1100.

The components 1105 to 1113 of the computer module 1101 typically communicate via an interconnected bus 1104 and in a manner that results in a conventional mode of operation of the computer system 1100 known to those in the relevant art. For example, the processor 1105 is coupled to the system bus 1104 using a connection 1118. Likewise, the memory 1106 and optical disk drive 1112 are coupled to the system bus 1104 by connections 1119. Examples of computers on which the described arrangements can be practised include IBM-PC's and compatibles, Sun Sparcstations, Apple Mac™ or a like computer systems.

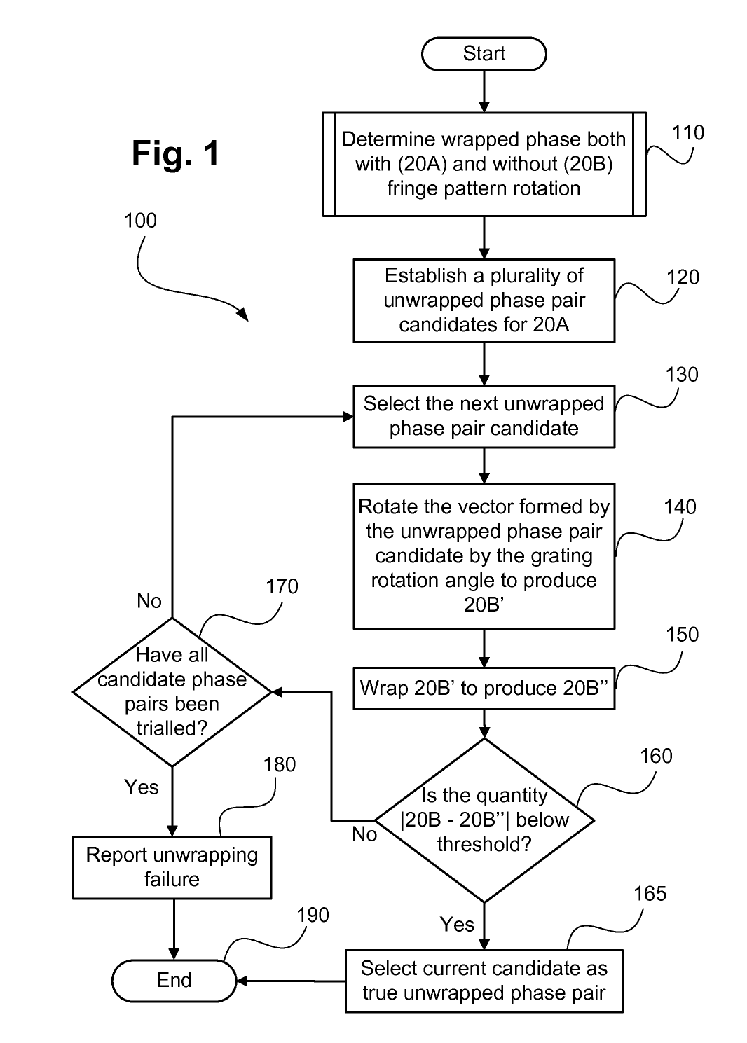

The methods of phase demodulation and unwrapping, together with extension methods such as depth estimation, may be implemented using the computer system 1100 wherein the processes of FIGS. 1 to 10D may be implemented as one or more software application programs 1133 executable within the computer system 1100. In particular, the steps of the methods are effected by instructions 1131 (see FIG. 11B) in the software 1133 that are carried out within the computer system 1100. The software instructions 1131 may be formed as one or more code modules, each for performing one or more particular tasks. The software may also be divided into two separate parts, in which a first part and the corresponding code modules performs the phase demodulation and unwrapping methods and a second part and the corresponding code modules manage a user interface between the first part and the user and perhaps extension applications such as depth estimation.

The software may be stored in a computer readable medium, including the storage devices described below, for example. The software is loaded into the computer system 1100 from the computer readable medium, and then executed by the computer system 1100. A computer readable medium having such software or computer program recorded on the computer readable medium is a computer program product. The use of the computer program product in the computer system 1100 preferably effects an advantageous apparatus for the unwrapping of phase images, useful for example for the assessment of texture of objects and scenes.

The software 1133 is typically stored in the HDD 1110 or the memory 1106. The software is loaded into the computer system 1100 from a computer readable medium, and executed by the computer system 1100. Thus, for example, the software 1133 may be stored on an optically readable disk storage medium (e.g., CD-ROM) 1125 that is read by the optical disk drive 1112. A computer readable medium having such software or computer program recorded on it is a computer program product. The use of the computer program product in the computer system 1100 preferably effects an apparatus for phase demodulation.

In some instances, the application programs 1133 may be supplied to the user encoded on one or more CD-ROMs 1125 and read via the corresponding drive 1112, or alternatively may be read by the user from the network 1120. Still further, the software can also be loaded into the computer system 1100 from other computer readable media. Computer readable storage media refers to any non-transitory tangible storage medium that provides recorded instructions and/or data to the computer system 1100 for execution and/or processing. Examples of such storage media include floppy disks, magnetic tape, CD-ROM, DVD, Blu-ray™ Disc, a hard disk drive, a ROM or integrated circuit, USB memory, a magneto-optical disk, or a computer readable card such as a PCMCIA card and the like, whether or not such devices are internal or external of the computer module 1101. Examples of transitory or non-tangible computer readable transmission media that may also participate in the provision of software, application programs, instructions and/or data to the computer module 1101 include radio or infra-red transmission channels as well as a network connection to another computer or networked device, and the Internet or Intranets including e-mail transmissions and information recorded on Websites and the like.

The second part of the application programs 1133 and the corresponding code modules mentioned above may be executed to implement one or more graphical user interfaces (GUIs) to be rendered or otherwise represented upon the display 1114. Through manipulation of typically the keyboard 1102 and the mouse 1103, a user of the computer system 1100 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 1117 and user voice commands input via the microphone 1180.

FIG. 11B is a detailed schematic block diagram of the processor 1105 and a “memory” 1134. The memory 1134 represents a logical aggregation of all the memory modules (including the HDD 1109 and semiconductor memory 1106) that can be accessed by the computer module 1101 in FIG. 11A.

When the computer module 1101 is initially powered up, a power-on self-test (POST) program 1150 executes. The POST program 1150 is typically stored in a ROM 1149 of the semiconductor memory 1106 of FIG. 11A. A hardware device such as the ROM 1149 storing software is sometimes referred to as firmware. The POST program 1150 examines hardware within the computer module 1101 to ensure proper functioning and typically checks the processor 1105, the memory 1134 (1109, 1106), and a basic input-output systems software (BIOS) module 1151, also typically stored in the ROM 1149, for correct operation. Once the POST program 1150 has run successfully, the BIOS 1151 activates the hard disk drive 1110 of FIG. 11A. Activation of the hard disk drive 1110 causes a bootstrap loader program 1152 that is resident on the hard disk drive 1110 to execute via the processor 1105. This loads an operating system 1153 into the RAM memory 1106, upon which the operating system 1153 commences operation. The operating system 1153 is a system level application, executable by the processor 1105, to fulfil various high level functions, including processor management, memory management, device management, storage management, software application interface, and generic user interface.

The operating system 1153 manages the memory 1134 (1109, 1106) to ensure that each process or application running on the computer module 1101 has sufficient memory in which to execute without colliding with memory allocated to another process. Furthermore, the different types of memory available in the system 1100 of FIG. 11A must be used properly so that each process can run effectively. Accordingly, the aggregated memory 1134 is not intended to illustrate how particular segments of memory are allocated (unless otherwise stated), but rather to provide a general view of the memory accessible by the computer system 1100 and how such is used.

As shown in FIG. 11B, the processor 1105 includes a number of functional modules including a control unit 1139, an arithmetic logic unit (ALU) 1140, and a local or internal memory 1148, sometimes called a cache memory. The cache memory 1148 typically include a number of storage registers 1144-1146 in a register section. One or more internal busses 1141 functionally interconnect these functional modules. The processor 1105 typically also has one or more interfaces 1142 for communicating with external devices via the system bus 1104, using a connection 1118. The memory 1134 is coupled to the bus 1104 using a connection 1119.

The application program 1133 includes a sequence of instructions 1131 that may include conditional branch and loop instructions. The program 1133 may also include data 1132 which is used in execution of the program 1133. The instructions 1131 and the data 1132 are stored in memory locations 1128, 1129, 1130 and 1135, 1136, 1137, respectively. Depending upon the relative size of the instructions 1131 and the memory locations 1128-1130, a particular instruction may be stored in a single memory location as depicted by the instruction shown in the memory location 1130. Alternately, an instruction may be segmented into a number of parts each of which is stored in a separate memory location, as depicted by the instruction segments shown in the memory locations 1128 and 1129.

In general, the processor 1105 is given a set of instructions which are executed therein. The processor 1105 waits for a subsequent input, to which the processor 1105 reacts to by executing another set of instructions. Each input may be provided from one or more of a number of sources, including data generated by one or more of the input devices 1102, 1103, data received from an external source across one of the networks 1120, 1102, data retrieved from one of the storage devices 1106, 1109 or data retrieved from a storage medium 1125 inserted into the corresponding reader 1112, all depicted in FIG. 11A. The execution of a set of the instructions may in some cases result in output of data. Execution may also involve storing data or variables to the memory 1134.

The disclosed arrangements use input variables 1154, which are stored in the memory 1134 in corresponding memory locations 1155, 1156, 1157. The arrangements produce output variables 1161, which are stored in the memory 1134 in corresponding memory locations 1162, 1163, 1164. Intermediate variables 1158 may be stored in memory locations 1159, 1160, 1166 and 1167.

Referring to the processor 1105 of FIG. 11B, the registers 1144, 1145, 1146, the arithmetic logic unit (ALU) 1140, and the control unit 1139 work together to perform sequences of micro-operations needed to perform “fetch, decode, and execute” cycles for every instruction in the instruction set making up the program 1133. Each fetch, decode, and execute cycle comprises:
(i) a fetch operation, which fetches or reads an instruction 1131 from a memory location 1128, 1129, 1130;

(ii) a decode operation in which the control unit 1139 determines which instruction has been fetched; and
(iii) an execute operation in which the control unit 1139 and/or the ALU 1140 execute the instruction.

Thereafter, a further fetch, decode, and execute cycle for the next instruction may be executed. Similarly, a store cycle may be performed by which the control unit 1139 stores or writes a value to a memory location 1132.

Each step or sub-process in the processes of FIGS. 1 to 5 is associated with one or more segments of the program 1133 and is performed by the register section 1144, 1145, 1147, the ALU 1140, and the control unit 1139 in the processor 1105 working together to perform the fetch, decode, and execute cycles for every instruction in the instruction set for the noted segments of the program 1133.

The methods of phase unwrapping and demodulation may alternatively be implemented in dedicated hardware such as one or more integrated circuits performing the demodulation functions or sub functions. Such dedicated hardware may include graphic processors, digital signal processors, FPGAs or ASICs, or one or more microprocessors and associated memories, which for example may find particular use in performing Fourier transformations and the like. Some specific implementations may be performed using embedded software within the x-ray device or a depth camera, rather than in a stand-alone computer.

### OVERVIEW

The arrangements to now be described in detail pertain to the extraction of unwrapped phase values from a set of wrapped (modulo 2π) phase values. The unwrapped phase values relate to an underlying physical property of the system under consideration. In the case of X-ray Talbot imaging, the unwrapped phase values relate to the spatial gradient of the optical path length difference across an object. In the case of structured illumination for depth estimation, the unwrapped phase values relate to the height of the surface of an object, relative to a given reference point (i.e. the surface topography of the object). As such the depth of the object at the portion can be estimated using the unwrapped phase for the portion of the image. The described method takes advantage of the fact that the unwrapped phase for a given object can be described as an N-dimensional vector, where each element of the vector contains the unwrapped phase values of fringe patterns projected along orthogonal spatial axes. These independent components of the unwrapped phase are represented vectorially because, whilst the spatial components of the true unwrapped phase vector may change under fringe pattern rotation, the magnitude of the unwrapped phase vector remains unchanged. The true unwrapped phase vector can then be identified as that candidate solution which has a magnitude which is invariant under fringe pattern rotation and which has phase components which, when wrapped, correspond to the measured wrapped phase values for the rotated and non-rotated fringe patterns.

In most real experimental systems there will be noise in the measurement of the wrapped phase values. Therefore, even if the true unwrapped phase vector is identified, there will still be a mismatch (error) between the wrapped phase components of the true unwrapped vector and the measured wrapped phase values. For this reason, a pre-defined error threshold is used. The candidate unwrapped phase vector which, when compared to the experimental wrapped phase data, produces an error which falls below the pre-defined error threshold is accepted as the true unwrapped phase vector.

### First Implementation

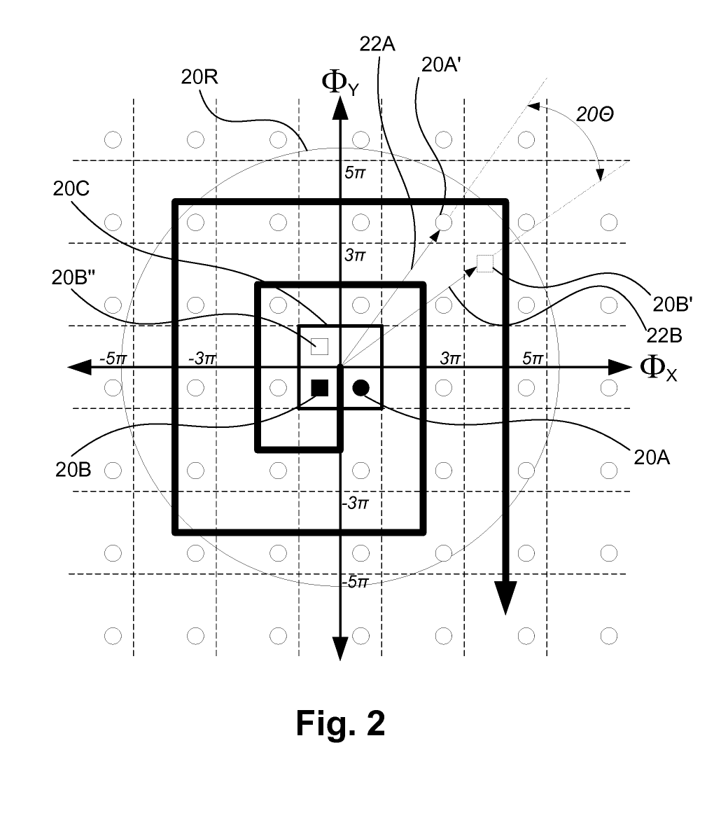

FIG. 1 shows an exemplary method 100 to determine unwrapped phase from wrapped phase values for the case where two orthogonal fringe patterns are used. A conceptual description or representation of the method 100 is provided in FIG. 2. The phase demodulation method 100 operates on a point by point basis and can be performed without additional information from neighbouring points.

As a pre-cursor to the method 100, fringe patterns are projected across the object of interest and the resulting intensity patterns are captured, for example using an appropriate arrangement as discussed above with respect to FIGS. 6 to 9, 11A and 11B. Processing of the captured intensity images by the computer 1101 allows wrapped phase values to be determined for each point (e.g. pixel) in the image. The fringe patterns may be projected simultaneously or they may alternatively be projected in a temporal sequence. This alternative approach allows the method to be implemented using one-dimensional fringe patterns which are periodic along one axis only. An example of how one-dimensional fringe patterns may be used to form a 2D fringe pattern is shown in FIG. 7D. There, a 1D fringe pattern is orthogonally rotated to recover a two-dimensional wrapped phase value. In the case of using one-dimensional fringe patterns, a minimum of four separate wrapped phase values must be captured, with the one-dimensional fringe pattern inclined at angles {θ1, (θ1+π/2), θ2, (θ2+π/2)}, where the angles are measured anticlockwise with respect to the Cartesian X axis. For two-dimensional crossed fringe patterns, the fringe pattern is periodic along two orthogonal axes. When using two-dimensional crossed fringe patterns, the wrapped phase values from only two orientations of the pattern are required; at angles {θ1, θ2} whereby the angles are measured anticlockwise with respect to the Cartesian X axis.

In a 1D implementation, there is no need to form a 2D crossed grating. To estimate wrapped phase values, a 1D grating may be used in the following way:

(a) a 1D grating (e.g. FIG. 7D) is used in its initial position θ1 to capture one-dimensional fringe pattern;

(b) the image of the one-dimensional fringe pattern is used to estimate one wrapped phase component, for example, the x component;

(c) the 1D grating is rotated by 90 degrees and another (second) image is captured; and

(d) then an estimate of a second wrapped phase (y) component can be determined from that second image.

The same sequence of steps are performed for rotation angle θ2, i.e. capture at least two images (at θ2 and θ2+90).

With reference to the above description, this approach may be referred to as ‘projecting in a temporal sequence’, while from a 2D grating it is possible to estimate the x and y phase components from a single captured image (“simultaneously”, as above).

The method 100 is preferably implemented using software stored on the HDD 1110 and executable by the processor 1105. The images captured from either the imaging system 1125 or the camera 820 may be stored in the HDD 1110 and processed by the processor 1105 using intermediate storage of all or parts of the images in the memory 1106. The method 100 starts with a first step 110 which operates to recover wrapped phase values for each of the fringe pattern orientations. This is depicted in FIG. 2 for a single pixel of an exemplary captured image. In this regard, any given point in a captured image will have two wrapped phase values, one in each of the single dimensions (1D) of X and Y, and two unwrapped phase values, again one in each of X and Y. In the exemplary illustrated case, a non-rotated fringe pattern phase value 20A (round dot) and a rotated fringe pattern phase value 20B (square dot) are shown with respect to a point (pixel) in the captured image, being coincident with the origin of the plot shown in FIG. 2, whose axes are phase in X and phase in Y. Because of wrapping, the detected (wrapped) phase values will always have a value between −π and +π. Known methods for recovering wrapped phase values from the analysis of fringe patterns include phase stepping and the Fourier Transform method. In the phase stepping method, the spatial frequency of the phase pattern remain unchanged, but the phase offset value is incremented. Phase stepping is achieved by altering the phase of the imaging source. In the X-ray case, this means translating the gratings (G0 or G1) in X and Y directions. For the optical case, the light source 810 may be rotated. For a given point in the scene, illuminated by a sinusoidal intensity pattern, the sequence of intensity values recorded as the phase offset is increased will describe a sinusoid. The phase offset of the sinusoid described by the temporal sequence will be the wrapped phase at that point. In the Fourier transform method, some or all of the captured image of the fringe pattern, modified by the object of interest, undergoes a two-dimensional Fourier transform. The spatial frequency spectrum of the captured intensity image contains the Fourier transform of the phase pattern of the object encoded in the captured image convolved with the Fourier transform of the undistorted projected fringe pattern. The unmodified fringe pattern (i.e. the fringe pattern that would be detected in the absence of a phase modulating object, such as seen in FIG. 7C) acts as a carrier frequency, allowing the phase information to be spatially filtered and inverse Fourier transformed to recover the wrapped phase values of all points in the scene.

For a given fringe pattern orientation, the wrapped phase values can therefore be recovered with the use of one or more captured images, depending upon the particular method chosen to recover the wrapped phase.

The first pair of wrapped phase values (φₓ^{N}, φ_{y}^{N}) are known as the non-rotated wrapped phase pair (denoted by superscript N), and together form a coordinate labelled 20A in FIG. 2. In addition to the non-rotated wrapped phase values at point (i,j) in the captured image, wrapped phase values are also obtained in step 110 for the corresponding point (i,j) in the image captured when the orthogonal fringe directions are either (i) inclined by angle θ2 with respect to the Cartesian X and Y axes, or (ii) rotated by angles θ1 and θ2, or (iii) rotated by angle θ2-θ1. This is the rotated condition. This second pair of wrapped phase values (φₓ^{R}, φ_{y}^{R}) are known as the rotated wrapped phase pair, and together form a coordinate labelled 20B, (denoted by the superscript R).

As the non-rotated wrapped phase values are wrapped, the coordinate described by (φₓ^{N}, φ_{y}^{N}) will lie within a bounding box 20C defined by the phase values −π to +π along each of the principal axes in two-dimensional phase space. The unwrapped phase values that correspond to the physical quantity being measured are therefore related to the wrapped phase values by the addition or subtraction of an integer number of multiples of 2π. A plurality of unwrapped phase pairs are then established by the processor 1105 according to step 120 based on the non-rotated wrapped phase pair 20A. Amongst those unwrapped phase pairs is the true solution that represents the correct unwrapped phase for the point (pixel location) under consideration. In the two-dimensional phase space diagram shown in FIG. 2, possible values of the unwrapped phase are represented as unfilled circles and are known as the unwrapped phase pair candidates. Whilst all possible unwrapped phase pair values extend out to infinity along both axes in two-dimensional phase space, only the unwrapped phase pair values within a predefined region are considered as candidates. In the example illustrated, the circle 20R defines the region within which unwrapped phase pair candidates are searched. Unwrapped phase pair candidates outside of the region 20R in FIG. 2 are not considered.

The values for the radius of the search zone, 20R, are determined by the specific properties of the particular application to which phase unwrapping is being applied. In the case of X-ray Talbot imaging, it has been empirically determined that for the specific system used, a search zone radius of three cycles (i.e. π, 3π and 5π) is appropriate for most specimen objects. In the event of an X-ray Talbot imaging system with higher sensitivity (i.e. a higher spatial frequency moiré pattern), a larger search zone radius would be preferable. The radius is generally dependent on the interaction of two factors, being (i) the periodicity of the fringe pattern, and (ii) the depth or flatness, as the case may be, of the object being imaged.

Once a finite number of non-rotated unwrapped phase pair candidates have been established in step 120, the unwrapped phase pair candidates are searched methodically by the processor 1105 according to a loop of steps 130 to 170. One search method is indicated in FIG. 2 as a spiral which begins at the origin and progresses out to consider unwrapped phase pair candidates with increasing distance from the phase-space origin.

For any given unwrapped phase pair candidate, a vector is formed. The vector extends from the origin of the coordinate system shown in FIG. 2 to the coordinate described by the two unwrapped phase values of the candidate solution. The purpose of forming a vector is that the magnitude of this vector will remain unchanged under the rotation of the fringe pattern. The magnitude of the unwrapped phase vector remains unchanged as it is a physical property of the object. In the event of identifying the true pair of unwrapped phase values from the plurality of solutions, wrapping the elements of the rotated vector formed from these phase values will yield a pair of wrapped phase values which will be most similar to the measured values of the rotated wrapped phase pair.

According to the desired searching method, step 130 selects the next unwrapped phase pair candidate which, in the example of FIG. 2, is the candidate 20A′, which is seen to have a corresponding vector 22A. In step 140, the vector 22A formed from the unwrapped phase pair candidate 20A′ is rotated in phase space by the angle θ2-θ1, represented in FIG. 2 by 200. This new, rotated vector 22B therefor has an equal magnitude to the vector 22A and terminates at the point labelled 20W, which is a rotated unwrapped phase pair. Once established, the components of the coordinate 20B′ are then wrapped modulo 2π according to step 150 to form another phase pair 20B″. The magnitude of the phase-space separation between the original rotated wrapped phase 20B and the wrapped rotated candidate 20B″ (written ‘|20B-20B″|’) is then calculated by the processor 1105 in step 160, which then assesses the separation. If the scalar quantity |20B-20B″| is below a pre-defined threshold, then the unwrapped phase pair candidate 20B′ is selected in step 165 as the true unwrapped phase pair for the non-rotated wrapped phase pair 20A, whereupon the method 100 ends at step 190. If the scalar quantity |20B-20B″| is above the pre-defined threshold, as in the example illustrated in FIG. 2, then the current candidate solution is discarded and not revisited, whereupon the method 100 proceeds to step 170.

From this it will be appreciated that the rotation of the vector 22A to the vector 22B to identify the rotated unwrapped phase pair 20B′, results in the phase pair 20B′ operating as an element to constrain the unwrapped solution 20A′ to the wrapped solutions within the bounding box 20C. As such, the phase pair 20W is a constraining element associated with the candidate element 20A′ using the second wrapped phase value 20B, with the association between the two being established by using the candidate element 20A′ and the predetermined rotation angle 20Θ.

The predetermined threshold value that is used in step 160 is related to the level of noise in the measurements, notably image noise. For systems with very low noise levels, the threshold can be made very low, and vice versa. The error in the wrapped phase values 20A and 20B is related to the noise in the recorded intensity values during the measurement of the wrapped phase. If estimates of the standard deviation of the noise in the intensity measurement can be made, then these measures of the intensity error can be mapped into the standard deviation of the error in the measured phase. In practice, the inventors have found it to be effective to set an upper limit of the threshold at three times the standard deviation of the phase error, although this value may vary depending upon the specific application.

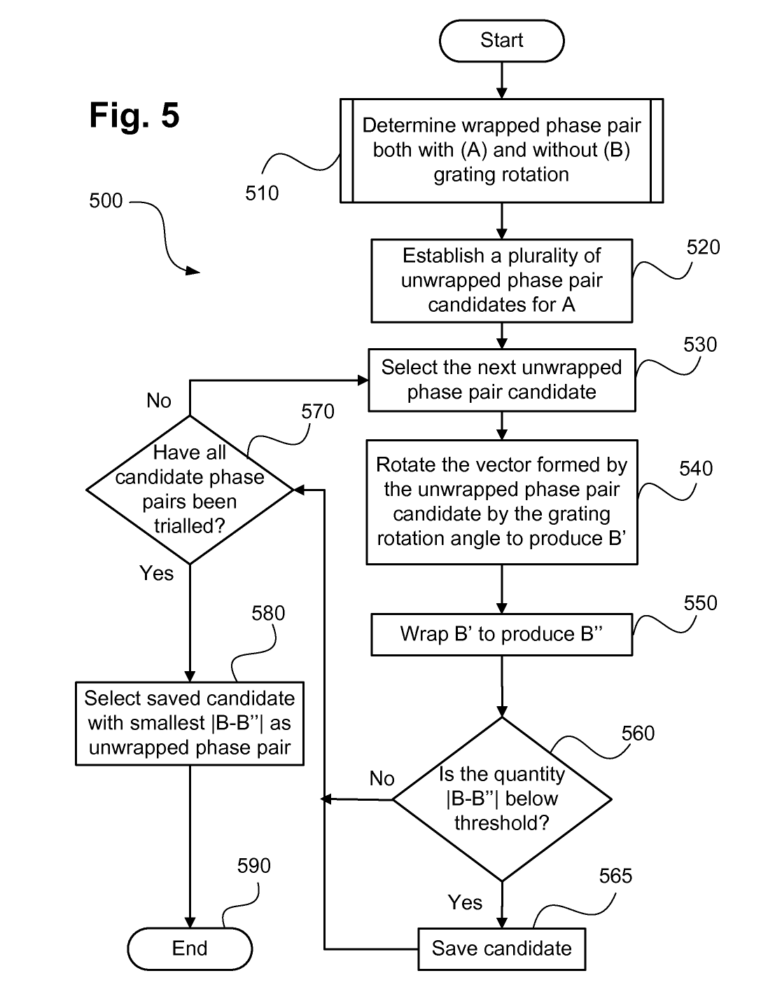

In the event that the outcome of step 160 is negative, the processor 1105 executing step 170 then determines whether all unwrapped phase candidates within the region 20R have been evaluated through steps 130 to 160. Where unwrapped phase candidates have not been evaluated, then the next unwrapped phase candidate in the desired sequence is evaluated using steps 130 to 160. If step 170 determines that all unwrapped phase candidates have been evaluated then the method 100 proceeds to step 180 to report that the method 100 has been unable to determine the true unwrapped phase pair for the pre-determined threshold value and the search region 20R before ending the method 100 at step 190. An alternative approach for step 180 is described below with reference to FIG. 5.

Once the method 100 has ended at step 190 for the particular point under consideration, the method 100 is then repeated across as many points in an image as required to reconstruct the full unwrapped phase map for the object.

### Second Implementation

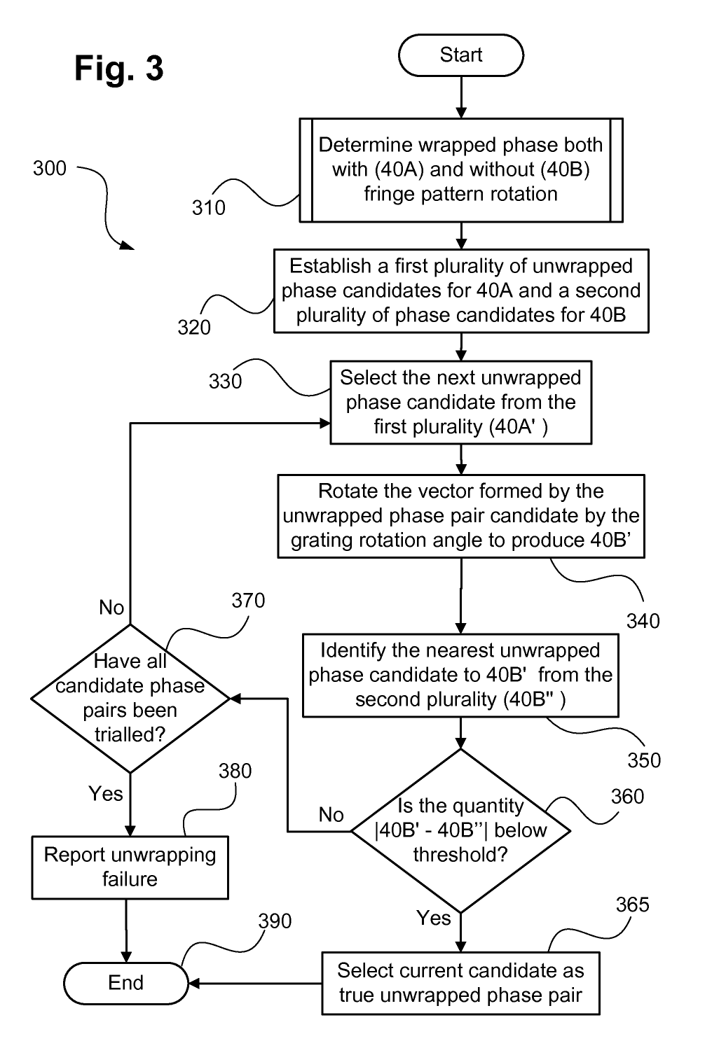

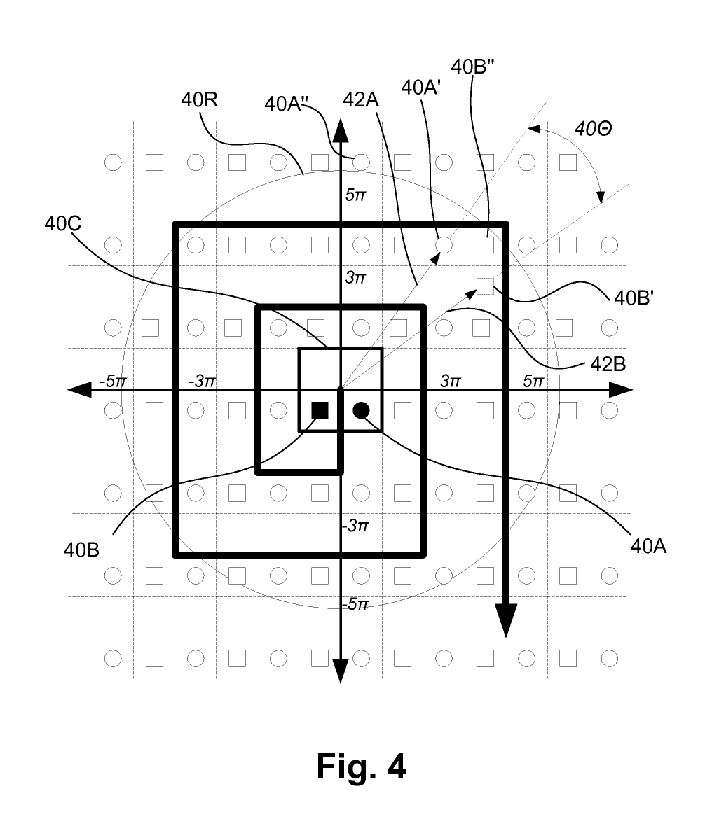

An alternative implementation of the phase unwrapping method described with reference to FIG. 1 (steps 140, 150, 160) will be described with reference to a method 300 shown in FIG. 3 and explained with reference to FIG. 4. In this implementation, a processing step can be saved by not wrapping the phase values of the rotated candidate phase pair solution. Like the method 100, the method 300 is preferably implemented in software stored in the HDD 1110 and again begins with the processor 1105 determining in step 310 the non-rotated and rotated wrapped phase pairs, (φₓ^{N}, φ_{y}^{N}) 40A and (φₓ^{R}, φ_{y}^{R}) 40B respectively seen in FIG. 4. In addition to forming a (first) plurality of unwrapped phase pair candidates 40A″ from the non-rotated phase pair (φₓ^{N}, φ_{y}^{N}) 40A across the search region 40R, using step 320 the processor 1105 forms a (second) plurality of unwrapped phase pair candidates 40B″ based on the rotated phase pair (φₓ^{R}, φ_{y}^{R}) 40B, again through the addition and subtraction of multiples of 2π (represented by the unfilled squares in FIG. 4). The next steps 330 and 340 in the method 300 are the same as corresponding steps 130 and 140 discussed above. After rotating the vector 42A formed by the unwrapped phase pair candidate by the fringe pattern or grating rotation angle θ2-θ1, the separation between the end point 40B′ of the rotated vector 42B and the nearest element of the second plurality 40B″ can be calculated at step 350. The magnitudes of the vectors 42A and 42B are equal. The quantity |40B′-40B″| is then compared in step 360 to the threshold value to determine if the candidate solution should to be selected in step 365 as the true unwrapped phase pair, or whether to search more unwrapped phase pair candidates from step 370.

The method 100 described with reference to FIG. 1 is a desirable approach in the sense that the search for the true unwrapped phase vector is not exhaustive. In the method 100, once a candidate solution satisfies the criteria of having an error which is below the pre-defined error threshold, that candidate solution is accepted as the true solution. This assumes that it is important that the method is time-efficient.

Where the accuracy of the unwrapped phase pair is the key criteria of success, an alternative implementation of the method 100 can be used to perform an exhaustive search of all candidate solutions within the pre-defined search region (‘R’ in FIG. 2). The exhaustive search implementation of the method 100 is described with reference to a method 500 shown in FIG. 5, which particularly implements an alternative decision making to that of steps 165, 170 and 180 of FIG. 1. In the method 500, steps 500 to 560 are identical to corresponding steps 110 to 160 described above. If the outcome of step (560) is ‘Yes’, then the unwrapped phase pair candidate is saved to a bank of possible best solutions to the true unwrapped phase pair, before continuing to step 565. The bank of possible best solutions may be formed in the memory 1106. If the outcome of step 560 is ‘No’, then the unwrapped phase pair candidate is rejected and is not revisited. Once all candidate phase pairs have been trialled (‘Yes’ outcome of step 570), the saved candidates in the bank are tested in step 580 such that the saved candidate with the smallest measure of the scalar quantity |B-B″| is selected as the true unwrapped phase pair, before the method ends at step 590. If there are no saved unwrapped phase pair candidates, then the method 500 reports an unwrapping failure for the point under consideration.

### Example(s)/Use Case(s)

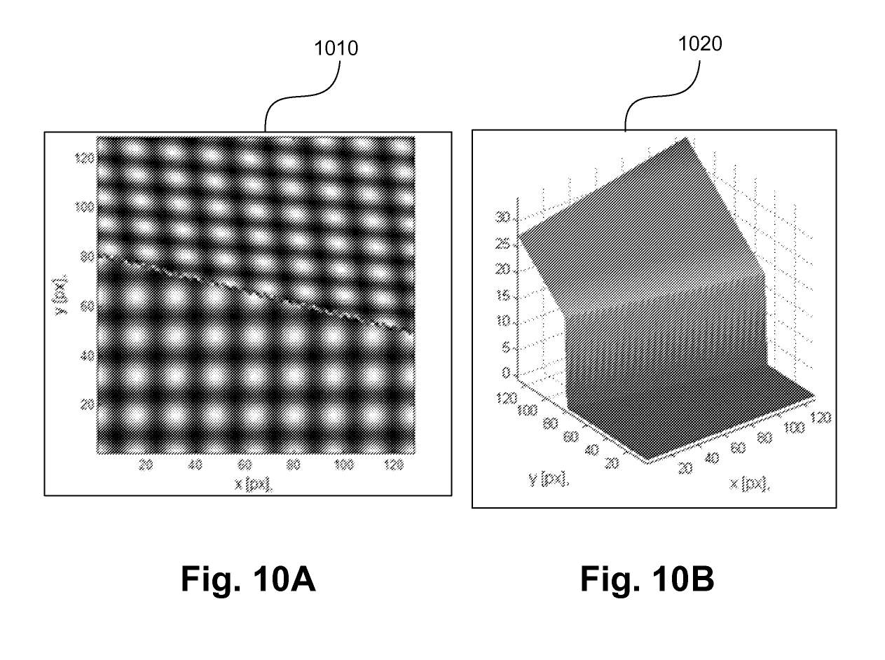

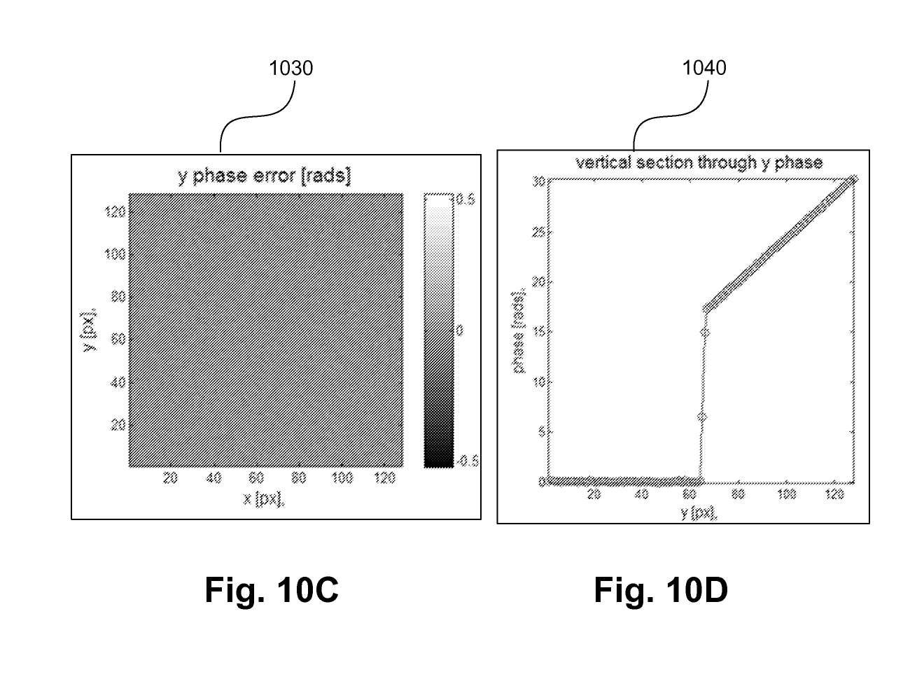

An example of the implementation of the described methods for X-Ray Talbot imaging is provided in FIGS. 10A-10D. The method 100 was experimentally implemented as programmatic simulation using the MATLAB programming environment. The program first simulated the moiré pattern that would be obtained from the X-ray Talbot self-image using a relative rotation between G1 610 and G2 630 of 7°, a discontinuous phase object and an image sensor 640 with a resolution of 128×128 pixels. The resulting simulated two-dimensional fringe pattern 1010 is shown in FIG. 10A.

The program simulated the use of a known 5-step phase shifting algorithm to recover the wrapped phase values required at step 110 of the method 100. For each pixel, the wrapped phase pair determined by the phase shifting process was used to generate a plurality of unwrapped phase pair candidates across a region extending from −5 cycles (−10π) to +5 cycles (+10π) in both the X and Y phase directions shown in FIG. 2 and corresponding to step 1120, thus defining the limits of the search region, 20R. This implementation therefore explored up to 120 unwrapped phase candidate solutions for each wrapped phase pair, applying the unwrapped phase pair candidate rotation at step 140, wrapping at step 150 and phase space separation criteria at step 160 to each candidate in a growing spiral from the phase space origin.

To test the robustness of the rotational phase unwrapping method 100 to noise, the simulated moiré images used to determine the rotated and non-rotated wrapped phase values included random Gaussian noise with a peak signal to noise ratio (PSNR) of 33.1 dB. The threshold value associated with step 160 was selected to be (π/7) radians in accordance with this level of noise in the system.

To test the ability of the described method 100 to unwrap phase values in the presence a discontinuity, the object modulating the moiré phase was chosen to be a truncated wedge shape, composed of a flat planar base, a steeply inclined discontinuity and then a less steeply inclined plane. The phase difference between adjacent pixels at the discontinuity of the phase object was designed to be more than 2π radians and could not therefore be unambiguously unwrapped using the two-dimensional spatial unwrapping methods described above.

The rotational phase unwrapping method identified an unwrapped phase candidate which met the threshold criteria of step 160 in 99.87% of cases for the Y-phase values and 99.95% of cases for the X-phase values. There were 22 unwrapping failures reported in the Y direction and 9 unwrapping failures reported in the X direction following step 180. Of the identified unwrapped phase candidate values, the root mean square (RMS) phase error between the unwrapped phase values and the phase values of the object used to generate the moiré pattern was less than 0.064 radians in the Y direction and less than 0.064 radians in the X direction.

FIG. 10B shows the unwrapped Y-phase 1020 for a truncated wedge object. The dark isolated points on the phase object surface represent unwrapping failures. FIG. 10C shows a grey-scale distribution 1030 of phase errors between the unwrapped phase values determined by the method 100 described in FIG. 1 and the phase values of the object used to generate the moiré pattern. FIG. 10D shows a transect 1040 along the X-axis of the unwrapped Y-phase shown in FIG. 10B, illustrating the size of the phase discontinuity that can be unwrapped using the disclosed methods.

The arrangements and methods described address problems associated with the prior art approaches discussed above. As the phase values are unwrapped on a point-by-point basis according to the presently disclosed methods, there are no issues with a path dependency seen in known spatial phase unwrapping methods. The present arrangements and methods are able to recover unwrapped phase values from a minimum of two wrapped phase values, representing a significant improvement over existing temporal phase unwrapping methods. Moreover, the methods are compatible with one-dimensional fringe projection methods, increasing the scope for wider application.

### INDUSTRIAL APPLICABILITY

The arrangements described are applicable to the computer and data processing industries and particularly for the imaging of samples having texture and depth.

The foregoing describes only some embodiments of the present invention, and modifications and/or changes can be made thereto without departing from the scope and spirit of the invention, the embodiments being illustrative and not restrictive.

We claim:

1. A phase unwrapping method for image demodulation, the method comprising:
receiving a plurality of images of a fringe pattern, the images being captured by rotating the fringe pattern by a predetermined rotation angle;
estimating a first wrapped phase value for a portion of a first image of the plurality of images and a second wrapped phase value for a corresponding portion of a second image of the plurality of images;
establishing a first plurality of elements associated with the first wrapped phase value;
for a candidate element from the first plurality of elements associated with the first wrapped phase value, determining a constraining element associated with the candidate element using the second wrapped phase value, wherein the association is established using the candidate element and the predetermined rotation angle; and,
unwrapping the phase for the portion of at least one of the first and second images using the candidate element based on the determined constraining element.

2. A method according to claim 1, where the fringe pattern is a two-dimensional fringe pattern.

3. A method according to claim 1, comprising generating the fringe pattern using a two-dimensional crossed grating.

4. A method according to claim 1, comprising capturing the plurality of images using at least two orthogonal gratings, wherein each grating forms a one-dimensional fringe pattern.

5. A method according to claim 4 comprising rotating two gratings together by the predetermined rotation angle.

6. A method according to claim 1 comprising estimating the wrapped phase values by capturing a plurality of images with predetermined phase steps of an imaging source from which the fringe patterns are formed.

7. A method according to claim 1, wherein the wrapped phase is in two-dimensional space comprising X and Y components.

8. A method according to claim 1, comprising establishing the candidate element by addition or subtraction of an integer number of cycles in at least one direction for the wrapped phase values.

9. A method according to claim 1, comprising rotating the candidate element by the predetermined rotation angle to determine the constraining element.

10. A method according to claim 9, further comprising establishing a second plurality of elements associated with the second wrapped phase value, the second plurality being established by addition an integer number of cycles in at least one direction to the second wrapped phase value.

11. A method according to claim 10, wherein the number of cycles is determined using at least one of the periodicity of the fringe pattern and an object being imaged.

12. A method according to claim 10, wherein the constraining element is selected from the second plurality using a distance between the candidate element rotated to the predetermined rotation angle and at least one element from the second plurality.

13. A method according to claim 10, wherein the constraining element from the second plurality is selected by considering a vector representation of the unwrapped phase values, so that a vector phase magnitude of the candidate element substantially equals vector phase magnitude of the constraining element, and thereby forming the pair of unwrapped phase values.

14. A method according to claim 13, wherein the unwrapping further comprises using the candidate element in the pair of unwrapped phase values as the true unwrapped phase value for the portion.

15. A method according to claim 12 wherein the constraining element is selected by comparing the distance between the candidate element rotated to the predetermined rotation angle and at least one element from the second plurality against a predetermined threshold, so that the distance is less than the predetermined threshold.

16. A method according to claim 15, wherein the unwrapping further comprises using the candidate element associated with the selected constraining element as the true unwrapped phase value for the portion.

17. A method according to claim 1, comprising capturing the plurality of images by projecting a two-dimensional fringe pattern onto an object.

18. A method for image demodulation by phase unwrapping, the method comprising:
receiving a plurality of images of a fringe pattern, the images being captured by rotating the fringe pattern by a predetermined rotation angle;
estimating a first wrapped phase value for a portion of a first image of the plurality of images and a second wrapped phase value for a corresponding portion of a second image of the plurality of images;
establishing a first plurality of elements associated with the first wrapped phase value;
rotating a candidate element from the first plurality of elements by the predetermined rotation angle to determine a constraining element associated with the second wrapped phase value; and
unwrapping the phase for the portion of the first image using the candidate element based on the determined constraining element.

19. A method according to claim 18 wherein the unwrapping comprises wrapping the constraining element and comparing a magnitude of a distance between the wrapped constraining element and the second wrapped phase value against a predetermined threshold, such that where the distance is less than the predetermined threshold, the candidate element is selected as the true demodulated unwrapped phase value for the portion.

20. A phase unwrapping method for image demodulation, the method comprising:
receiving a plurality of images of a fringe pattern, the images being captured by rotating the fringe pattern by a predetermined rotation angle;
estimating a first wrapped phase value for a portion of a first image of the plurality of images and a second wrapped phase value for a corresponding portion of a second image of the plurality of images;
for a candidate element formed by applying an integer number of cycles to the first wrapped phase value, determining a constraining element associated with the candidate element using the second wrapped phase value, wherein the association is established using the candidate element and the predetermined rotation angle; and,
unwrapping the phase for the portion of at least one of the first and second images using the candidate element based on the determined constraining element.

21. An X-ray Talbot interferometry system comprising:
an imaging system for capturing a plurality of images of a fringe pattern formed by a plurality of gratings using the Talbot effect, the images being captured by rotating the fringe pattern by a predetermined rotation angle; and
a processor system configured to demodulate the images using phase unwrapping, the processor system being operable to:
estimate a first wrapped phase value for a portion of a first image of the plurality of images and a second wrapped phase value for a corresponding portion of a second image of the plurality of images;
establish a first plurality of elements associated with the first wrapped phase value;
for a candidate element from the first plurality of elements, determine a constraining element associated with the candidate element using the second wrapped phase value, wherein the association is established using the candidate element and the predetermined rotation angle; and
unwrap the phase for the portion of the first image using the candidate element based on the determined constraining element.

22. A depth estimation system comprising:
a source for projecting a two-dimensional fringe pattern onto an object, the projecting including a plurality of rotations of the fringe pattern through a predetermined rotation angle;
an imaging device for capturing a plurality of images of the fringe pattern on the object from the plurality of rotations; and
a processor system configured to demodulate the images using phase unwrapping, the processor system being operable to:
estimate a first wrapped phase value for a portion of a first image of the plurality of images and a second wrapped phase value for a corresponding portion of a second image of the plurality of images;
establish a first plurality of elements associated with the first wrapped phase value;
for a candidate element from the first plurality of elements, determine a constraining element associated with the candidate element using the second wrapped phase value, wherein the association is established using the candidate element and the predetermined rotation angle;
unwrap the phase for the portion of the first image using the candidate element based on the determined constraining element; and
estimate a depth of the object at the portion using the unwrapped phase for the portion.
